(19) United States
(12) Patent Application Publication
(10) Pub. No.: US 2015/0271554 A1
(43) Pub. Date: Sep. 24, 2015

(54) UNIFIED RATING SYSTEM AND METHOD FOR SELECTIVELY BLOCKING CONTENT

(71) Applicant: Telefonaktiebolaget L M Ericsson (PUBL), Stockholm (SE)

(72) Inventor: Bharath Shetty, Mountain View, CA (US)

(73) Assignee: Telefonaktiebolaget L M Ericsson (PUBL), Stockholm (SE)

(21) Appl. No.: 14/218,505

(22) Filed: Mar. 18, 2014

(51) Int. Cl. H04N 21/475; H04N 21/454; G06F 17/30

(52) U.S. Cl. CPC H04N 21/4751; G06F 17/3053; G06F 17/3051; G06F 17/30598; G06F 17/30575; G06F 17/30917; G06F 17/30678; G06F 17/30867; H04N 21/4542

(57) ABSTRACT

A universal content rating scheme that involves defining a set of universal rating categories, each configured with at least a lock bit associated therewith, and mapping each universal rating category to at least one rating category of a content rating system available with respect to content from one or more content sources. The universal rating categories may be selectively blocked and/or unblocked by appropriately configuring lock bit logic associated therewith, which blocking/unblocking settings may be applied to all existing content rating categories based on their mapping to corresponding universal rating categories

### FIELD OF THE DISCLOSURE

The present disclosure generally relates to content consumption technologies. More particularly, and not by way of any limitation, the present disclosure is directed to effectuating a unified rating system and method for selectively blocking content.

### BACKGROUND

Content rating systems give viewers an idea of the suitability of a television program or other media content for children and/or adults. In content consuming devices or content providing servers, for example, a Parental Locking system may be used to block or unblock access to various types of content based on the applicable content rating systems.

Existing content rating systems vary based on the content type, country or geographical location of content consumption, and/or where the content is generated. As various types of content, potentially from around the world, becomes available on a range of devices, users may increasingly encounter different, and perhaps somewhat unfamiliar, rating systems in their consumption environment, which may be continually changing.

### SUMMARY

The present patent disclosure is broadly directed to systems, methods, apparatuses, devices, and associated non-transitory computer-readable media for effectuating a universal/unified content rating scheme wherein a subscriber can conveniently implement a set of “reference controls” with respect to a number of different content rating systems available for several types of content, which may be consumed on various types of client devices over disparate networks. In one embodiment, a universal content rating method is disclosed that comprises, inter alia, the following features: defining a set of universal rating categories, each configured with at least a lock bit associated therewith; mapping each universal rating category to at least one rating category of a content rating system available with respect to content from one or more content sources; enabling at least one of blocking and unblocking of the universal rating categories by appropriately configuring lock bit logic associated therewith; and triggering at least one of blocking and unblocking of rating categories of each available content rating system based on the mapping of the rating categories to corresponding universal rating categories. In one implementation, one or more of the acts of defining, mapping, enabling, and triggering may be performed at a client device. In another implementation, one or more of such acts may be performed by at a server node operative to serve one or more subscribers.

In another aspect, an embodiment of a content consumption method is disclosed which comprises, inter alia, the following features: receiving a request for accessing content, or receiving the requested content, the content having a rating system associated therewith; determining that a rating category of the content is mapped to a category in a Unified Rating System (URS) having a plurality of universal content rating categories; and allowing/disallowing accessing/consuming of the content based on a lock bit logic associated with the universal content categories of the URS.

In a still further aspect, an embodiment of a Unified Rating System (URS) for facilitating parental control over content is disclosed. The claimed URS embodiment comprises, inter alia, the following features: a plurality of memory locations configured to identify or otherwise define a set of universal content rating categories; a plurality of lock bit locations (e.g., single bit or multi-bit) respectively corresponding to the set of universal content rating categories; and a lock bit logic block configured such that setting a particular lock bit location to a Boolean “True” value is operative to block accessing of content having a rating category that is mapped to a universal content rating category having its lock bit set to the Boolean “True” value, wherein the memory locations, lock bit locations and the lock bit logic block may be implemented in a suitable persistent or nonvolatile memory.

In yet another aspect, an embodiment of a user equipment (UE) device is disclosed. The claimed UE device comprises, inter alia, the following features: one or more processors; a user interface configured to facilitate, under control of the one or more processors executing stored program instructions, an end user to: define a set of universal content rating categories, each universal content rating category configured with a lock bit associated therewith; map each universal content rating category to at least one rating category of an existing content rating system available with respect to content from one or more content sources; and enable blocking of one or more of the universal content rating categories by appropriately configuring respective lock bits, whereby setting a particular lock bit to a Boolean “True” value is operative to block accessing of content having a rating category that is mapped to a universal content rating category having its lock bit set to the Boolean “True” value; and a synchronization block operative to synchronize mapping of the universal rating categories with the end user's profile stored in a service operator database.

In still further aspects, one or more embodiments of a non-transitory computer-readable medium containing computer-executable program instructions or code portions stored thereon are disclosed for performing one or more embodiments of the methods set forth herein when executed by a processor of a network node, element, UE device, and the like.

Advantages of the present invention include, but not limited to, providing a single rating system that exerts uniform control over all existing rating systems that may be configurably mapped to user-defined classes based on users' preferences, choices, viewing habits and the like. Additional advantages may include the following: auto blocking/unblocking of all other rating systems with a single user action; providing a customizable and scalable rating system by the user or server/operator in addition to supporting multiple client devices and networks; obviating the need for users to understand and be conversant and up-to-date with every rating system; efficiently managing the complexities arising from having multiple rating systems; and facilitating a particularly useful and convenient scheme for the global audience/content and for the devices which may be carried around the world.

Further features of the various embodiments are as claimed in the dependent claims. Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example content distribution and consumption environment wherein one or more embodiments of the present patent application may be practiced;

FIG. 2 depicts an example unified/universal rating system (URS) and associated lock bit logic implementation for effectuating control over content consumption according to an embodiment of the present patent application;

FIGS. 3 and 4 depict further examples of a URS and associated lock bit logic implementation with additional details;

FIG. 5 depicts an example client device implementation of a URS and associated user profile for practicing an embodiment of the present patent disclosure;

FIG. 6 depicts an example network server implementation of a URS and associated user profile for practicing another embodiment of the present patent disclosure;

FIG. 7 depicts an example methodology for automatically updating the URS configuration across a plurality of client devices of a user;

FIG. 8 depicts a flowchart of various blocks, steps and/or acts with respect to a universal content rating method according to an embodiment of the present patent disclosure;

FIGS. 9-11 depicts flowcharts of various blocks, steps and/or acts illustrative of additional/alternative embodiments of the present patent disclosure; and

FIG. 12 depicts a block diagram of example user equipment (UE) operable as a client device for purposes of the present patent application.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific components. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices or nodes (e.g., a subscriber client device or end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such network elements may typically include a set of one or more processors coupled to one or more other components, such as one or more storage devices (e.g., non-transitory machine-readable storage media) as well as storage database(s), user input/output devices (e.g., a keyboard, a touch screen, a pointing device, and/or a display), and network connections for effectuating signaling and/or bearer media transmission. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device or network element may be configured to store code and/or data for execution on one or more processors of that element, node or electronic device for purposes of implementing one or more techniques of the present disclosure.

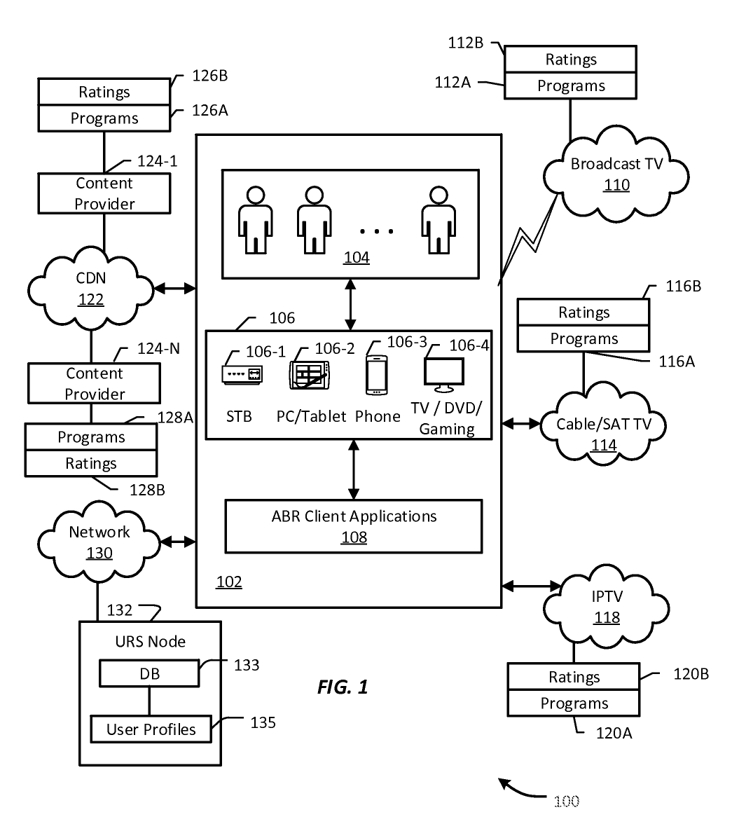

Referring now to the drawings and more particularly to FIG. 1, depicted therein is an example content distribution and consumption environment 100 wherein one or more embodiments of the present patent application may be practiced. A subscriber environment 102 is illustrative of various content consumption scenarios, including but not limited to, e.g., a home or away from home, wherein a plurality of users 104 may operate one or more client devices or user equipment (UE) devices 106 with respect to consuming content from a number of sources. As such, client UE devices may include set-top boxes (STBs), personal/digital video recorder (PVR/DVR) equipment, workstations, personal computers, laptops, tablets, palm tops, mobile phones, smartphones, multimedia phones, Voice Over Internet Protocol (VOIP) phones, mobile/wireless user equipment, high definition TV terminals, portable media players, gaming systems or consoles (such as the Wii®, Play Station 3®, Xbox 360®), etc., that may access or consume content/services for purposes of one or more embodiments set forth herein. By way of illustration, STB units 106-1, PC/tablets 106-2, smartphones 106-3 and TV/DVD/Gaming consoles 106-4, etc. are shown in FIG. 1 for purposes of receiving, downloading and/or otherwise consuming a variety of programs, TV shows, movies/videos on demand, music, computer/video games or other entertainment programs such as cartoons, comics, anime/manga programs, graphic/visual novels, etc. (cumulatively referred to herein as “content”) from several sources via appropriate delivery/distribution networks using any known or heretofore unknown technologies. Content sources may be geographically unlimited, i.e., they may comprise local or domestic sources with respect to the users, or may be international, and content provided by the content sources may accordingly be subject to various appropriate rating systems, e.g., national, regional, supra-national, country-specific, foreign-based, etc., which may be applied by governmental regulatory bodies, private industry entities, groups or associations, and the like. Furthermore, it should be appreciated that different types of content from a geographic region (e.g., a country) may have different rating schemes, e.g., movies having one content rating system whereas video games having another content rating system, each with its own categories, classifications, certifications, and associated descriptors and/or graphic icons.

Users 104 may consume content via broadcast TV channels from any number of TV stations, generally represented as broadcast TV 110, wherein various types of TV programs 112A may be received for viewing. Associated with the TV programs 112A there may be one or more suitable rating systems 112B, which may be domestic or foreign (depending the client devices' capability to receive foreign broadcast TV shows). For example, TV shows rated in the U.S. under the “TV Parental Guidelines” established by the National Association of Broadcasters, the National Cable Television Association (used in association with VCHIP technology) may include ratings such as TV-Y (all children), TV-Y7 (older children), TV-Y7-FV (older children, may be more intense than other TV-Y7 shows), TV-G (general audience—all ages), TV-PG (parental guidance suggested; may include sub-ratings or categories for violence, sexual situations, strong language, and suggestive dialogue), TV-14 (may be unsuitable for children under 14), and TV-MA (may be unsuitable for children under 17). Likewise, TV programming in Canada may be rated using categories such as, e.g., Exempt (shows which are exempt from ratings such as news and sports programming), C (programming suitable for children ages of 2-7 years; no profanity or sexual content of any level allowed; contains little violence), C8 (suitable for children ages 8+; low level violence and fantasy horror is allowed; no foul language is allowed, but occasional “socially offensive and discriminatory” language is allowed if in the context of the story; no sexual content of any level allowed), G (suitable for general audiences; programming suitable for the entire family with mild violence, and mild profanity and/or censored language), PG (parental guidance; moderate violence and moderate profanity is allowed, as is brief nudity and sexual references if important to the context of the story), 14+(programming intended for viewers ages 14 and older; may contain strong violence and strong profanity, and depictions of sexual activity as long as they are within the context of a story), and 18+(programming intended for viewers ages 18 and older; may contain explicit violence and sexual activity, programming with this rating cannot air during prescribed timing windows).

Users 104 may also consume content via various cable and/or satellite TV networks 114 wherein content programs 116A may have respective rating system(s) 116B associated therewith. In addition to the TV programming ratings described above, content such as movies shown on cable/satellite channels may have ratings established by industry groups (e.g., the Motion Picture Association of America (MPAA) and the National Association of Theater Owners) that encompass the following categories: G (general audience—all ages), PG (some material may not be suitable for children), PG-13 (some material may be inappropriate for children under 13, R (under 17 requires accompanying parent or adult guardian), and NC-17 (no one 17 or under admitted). Further, if the content is foreign-originated, it may have appropriate foreign motion picture ratings. For example, Canadian movies may have the following ratings (outside Quebec): G (general Audience—suitable for all ages), PG (parental guidance advised; there is no age restriction but some material may not be suitable for all children), 14A (persons under 14 years of age must be accompanied by an adult), 18A (persons under 18 years of age must be accompanied by an adult), R (restricted; admittance restricted to people 18 years of age or older), and A (admittance restricted to people 18 years of age or older; sole purpose of the film is the portrayal of sexually explicit activity and/or explicit violence). As a further example, German movies may be classified according to the Voluntary Self-Regulation of the Film Industry or FSK (in German), classificaiton scheme having the following categories: FSK 0 (no age restriction—white sign), FSK 6 (no children younger than 6 years admitted—yellow sign), FSK 12 (children 12 or older admitted, children between 6 and 11 only when accompanied by parent or a legal guardian—green sign), FSK 16 (children 16 or older admitted, nobody under this age admitted—blue sign), and FSK 18 (no youth admitted; only adults—red sign). In this scheme, unrated programming may be deemed “educational programming, which is not specifically issued by the FSK, but may be self-applied to films seeking to educate their audience (e.g. documentaries, instructional films, etc.), provided they do not contain any material “evidently harmful to the development of children (unrestricted distribution).

Similarly, users 104 may further consume content via IPTV networks 118 or via content delivery networks (CDN) 122, which content may also have applicable rating systems (domestic and/or foreign) depending on the programming content and its origin/distribution. Accordingly, one or more client devices 106 may be configured to receive content using streaming technologies such as adaptive bitrate (ABR) streaming. Such client devices may be provided with suitable streaming client applications 108 that facilitate downloading, decoding and rendering of content from one or more content/media servers disposed in a suitable CDN that may be a public CDN, a private CDN or a hybrid CDN. By way of example, content delivered via CDN 122 using ABR streaming techniques may be encoded to support Microsoft® Silverlight® Smooth Streaming, HTTP streaming (for instance, Dynamic Adaptive Streaming over HTTP or DASH, HTTP Live Streaming or HLS, HTTP Dynamic Streaming or HDS, etc.), Icecast, and so on. Further, it should be appreciated that IPTV sources 118 and content providers 124-1 to 124-N may be located in different countries, and therefore may provide content rated under corresponding different rating systems. Example IPTV programming content 120A is therefore illustrated with its rating schemes 120B whereas example programming content 126A, 128A provided by respective content providers 124-1, 124-N is illustrated with corresponding rating schemes 126B, 128B. It should be appreciated IPTV and/or CDN content may comprise audio/video content or program segments, streaming or static (e.g., recorded over-the-air free network television (TV) shows or programs, pay TV broadcast programs via cable networks or satellite networks, free-to-air satellite TV shows, simulcast programs, etc.), Over-The-Top (OTT) and video-on-demand (VOD) or movie-on-demand (MOD) shows or programs, time-shifted TV (TSTV) content, as well as other content assets provided by content publishers, owners or providers, including but not limited to software files, executable computer code or programs, online electronic games, Internet radio shows/programs, entertainment programs, educational programs, movies, music video programs, and the like, each of which may be subject to or provided with one or more suitable rating systems.

Although not explicitly shown in FIG. 1, one skilled in the art will recognize that users 104 may also consume content via media products such as home videos, video gaming cartridges, audio CDs, etc. that may also have appropriate rating systems indicated or embedded therein. Moreover, certain type of content may be rated in more than one rating system. For example, a movie that was originally filmed in the U.S. and then translated into French for a French audience may contain ratings both for U.S. audiences and for French viewers. Such a movie also may contain a third set of ratings for a French Canadian viewer, for instance. Likewise, gaming content may also multiple rating systems depending on its origin and/or distribution. By way of illustration, the Entertainment Software Rating Board (ESRB) governing the gaming content in the U.S. and Canada assigns the following ratings to games: EC (Early Childhood), E (Everyone), E10+(Everyone 10+), T (Teen), M (Mature), RP (Rating Pending), and AO (Adult Only), in addition to incorporating one or more of 32 or so “content descriptors” that provide detailed information about specific types and levels of objectionable content in a game, including categories govering different levels of violence, language, sexual content, nudity, use of alcohol or drugs, crude and mature humor, or gambling, etc. Gaming content ratings may also differ based on the device platform on which a game is to be played. For example, the Computer Entertainment Rating Organization (CERO) in Japan assigns ratings to console game content (video games on consoles) whereas a separate body, the Ethics Organization of Computer Software (EOCS) issues ratings with respect to PC gaming content. Furthermore, many rating systems may provide for further refinement of categories or ratings, e.g., sub-categorires within a rating category.

Regardless of various types of content and content rating systems (CRS) that may be extant in the example content consumption/distribution environment of FIG. 1, a unified (or, synonymously, universal) rating system (URS) and methodology may be implemented in accordance with the teachings of the present disclosure to advantageously overcome the issues set forth in the Background section hereinabove. As will be seen in detail below, some embodiments and/or aspects of the URS may be provided at the client UE device level, whereas some embodiments/aspects may involve implementation at a network server node. In still other embodiments, both UE devices and network server node may be provided with appropriate features for harmonizing or otherwise synchronizing the URS-based content filtering capability across several client devices in a configurable manner. In FIG. 1, an example network 130 may be a private network, a public network (e.g., the Internet), an enterprise network, a service operator/provider network, and the like that may be configured to implement at least certain aspects relative to a URS and associated methodology as a cloud-based or web-based service. Reference numeral 132 is illustrative of a network node disposed in network 130 (which may hereinafter be referred to as a URS node or service element) that includes a database 133 associated and/or integrated with a plurality of user profiles 135 for configuring a URS-based content filtering system on a subscriber-by-subscriber basis, wherein a subscriber account may be associated with a plurality of users (e.g., members of a family) and corresponding client UE devices.

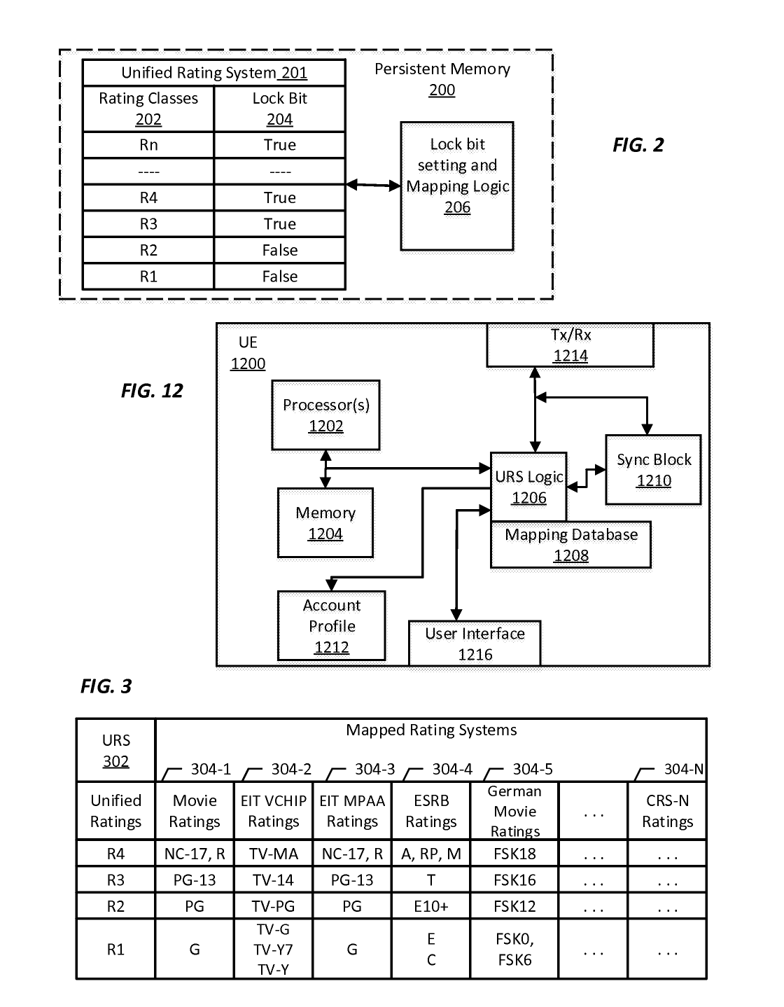

FIG. 2 depicts an example URS 201 and associated lock bit logic setting and mapping mechanism 206 for effectuating control (e.g., parental filtering control) over content access, reception and/or consumption according to an embodiment of the present patent application. URS 201 may be implemented as a table or other suitable database structure, e.g., as part of a persistent memory 200, wherein a plurality of unified rating categories or classes 202 may be defined, determined or otherwise configured, which may be at the discretion of a subscriber, network operator providing a URS service, or both. It should be appreciated that such unified rating categories or URCs may be realized as a set of nonvolatile memory (NVM) locations, registers or other suitable “containers” that identify the URC names or other indicia. An example classificatory definition scheme can be highly individualized and may be set/reset (i.e., programmable) depending on the changing usage scenarios/circumstances associated with a group of individuals, e.g., based on changes in users' ages, maturity levels, viewing habits and preferences, addition/deletion of users, client UE devices and upgrades, addition/deletion of content/communications networks, etc. (i.e., scalable). URCs 202 may take on or be identified with any textual names, alphanumerical terms, icons, symbols, codes, or other indicia, as long as each URC may be configured with a binary or Boolean logic value associated therewith by way of a suitable lock bit setting logic 206. In one implementation, each URC may be associated or provided with a single lock bit that can take on either a Boolean “True” value or a Boolean “False” value, illustrated as a lock bit structure 204 in FIG. 2 that may be realized as a set of NVM locations corresponding to URCs 202. Depending on positive logic or negative logic implementation, a “True” value can be a logic level representative of a binary “1” or “0”. Likewise, a “False” value can be implemented as a complementary logic level accordingly. It should be appreciated that a multi-bit implementation may also be provided with advanced digital logic circuitry for effectuating lock bit logic relative to the plurality of URC categories 202.

By way of illustration, URCs 202 may be exemplified as a set of classes R1, R2, R3, . . . , Rn, that represent user-defined rating categories under a particular URS implementation. Depending on positive or negative logic implementation, Rn, R4 and R3 are each shown in FIG. 2 as having a “True” value for their respective lock bit logic while R1 and R2 are each shown as having a “False” value for their respective lock bit logic. In accordance with the teachings herein, setting a lock bit to a particular Boolean value may be configured to operate as a block filter (in one implementation) or as a pass filter (in another, complementary implementation) with respect to any content having an existing rating category under current rating systems that is mapped to a URC having that Boolean value. For example, a particular content having a rating category X that is mapped to URC R4 whose lock bit logic has been set to “True” may be prevented from being downloaded or otherwise consumed by a certain user on a specific client UE device associated therewith. Likewise, content having a rating category Y that is mapped to URC R2 may not be blocked. It should be appreciated that depending the content/media file implementation, only select portions of a particular content may be blocked or passed through (e.g., allowing only certain chapters, levels or episodes of a game). To effectuate appropriate associative relationships between a set of configurable URCs and any number/type of current content rating systems, suitable mapping mechanisms may be provided that may involve subscriber and/or service operator interaction, either at a network level or at a subscriber device level, generally shown as mapping block 206, part of which may involve execution of program instructions stored in NVM. One skilled in the art will recognize upon reference hereto that lock bit logic setting functionality and mapping functionality may be decoupled in certain implementations, e.g., located at different components and/or involving user control for certain aspects while the other aspects being controlled by the service operator.

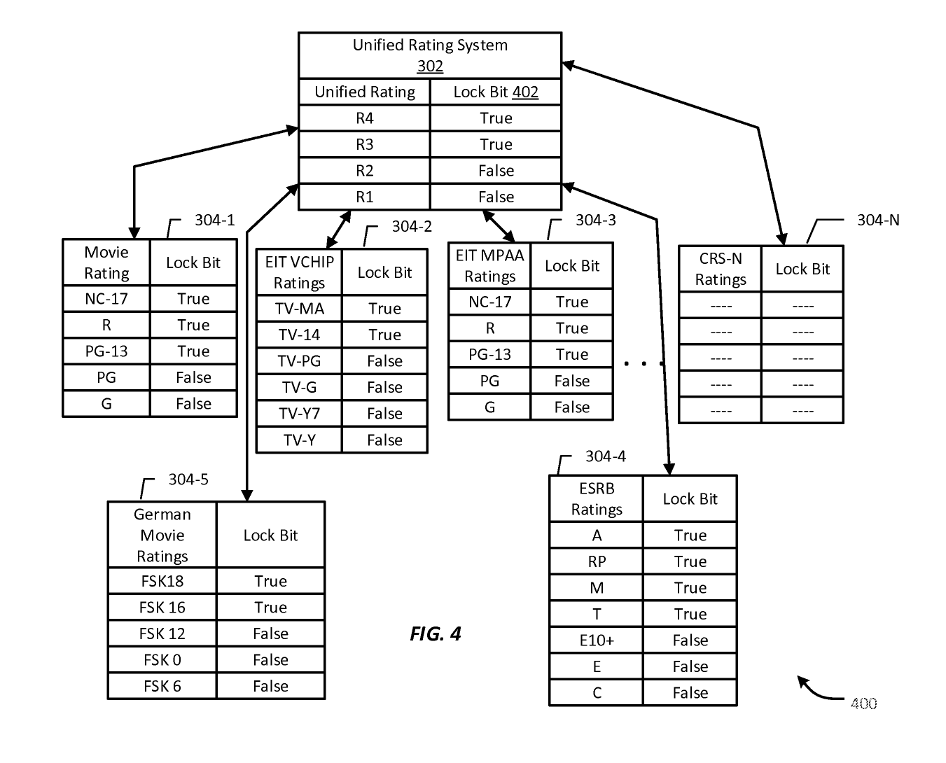

FIGS. 3 and 4 depict further examples of a URS and associated lock bit logic implementation with additional details. In particular, an embodiment of a mapping mechanism is illustrated in FIG. 3 wherein URCs R1 to R4 are mapped to a plurality of existing rating systems 304-1 to 304-N, which may be cumulatively referred to as mapped rating systems. Reference numeral 304-1 refers to a U.S. Movie Rating system according to an example industry governing body wherein its rating categories are mapped to different URCs as follows: NC-17 and R are mapped to URC R4, PG-13 is mapped to R3, PG is mapped to R2 and G is mapped to R1. Likewise, EIT VCHIP ratings 304-2, EIT MPAA ratings 304-3, ESRB ratings 304-4 and German FSK ratings for movies 304-5 are respectively mapped to different URCs. Accordingly, the entire set of example mapping relationships for the four URCs are as follows: R4 is mapped to (NC-17, R) of Movie Ratings, (TV-MA) of EIT VCHIP Ratings, (NC-17, R) of EIT MPAA Ratings, (A, RP, M) of ESRB Ratings and (FSK 18) of German Movie Ratings; R3 is mapped to (PG-13) of Movie Ratings, (TV-14) of EIT VCHIP Ratings, (PG-13) of EIT MPAA Ratings, (T) of ESRB Ratings and (FSK 16) of German Movie Ratings; R2 is mapped to (PG) of Movie Ratings, (TV-PG) of EIT VCHIP Ratings, (PG) of EIT MPAA Ratings, (E10+) of ESRB Ratings and (FSK 12) of German Movie Ratings; and finally, R1 is mapped to (G) of Movie Ratings, (TV-G, TV-Y7, TV-Y) of EIT VCHIP Ratings, (G) of EIT MPAA Ratings, (E, C) of ESRB Ratings and (FSK 0, FSK 6) of German Movie Ratings. So, If R4 rating is locked in the example URS embodiment, then (NC-17, R) of Movie Ratings, (TV-MA, TV-14) of EIT VCHIP Ratings, (NC-17, R) of EIT MPAA Ratings, (A, RP, M) of ESRB Ratings and (FSK18) of German Movie Ratings are all automatically locked or blocked, which may be effectuated by simply setting the lock bit logic associated with URC R4 to the Boolean “True” value. Likewise, individual lock bit settings of R1-R3 can be used to configure a desired set of blocking/filtering control parameters with respect to content rated under the existing rating systems as illustrated in FIG. 4.

Taking FIGS. 3 and 4 together, example lock bit logic settings 402 are shown relative to the four URCs, R1-R4, wherein R1 and R2 are set to “False” while R3 and R4 are set to “True”. Because of the mapping relationship associations of FIG. 3, setting the URC lock bit logic may be cascaded, triggered or otherwise applied across the board to the rating categories of each mapped rating system. Accordingly, the categories of the Movie Rating system 304-1 are blocked or unblocked as follows, assuming that the Boolean value of “True” and “False” are configured for blocking and unblocking, respectively: (NC-17, R, PG-13) are blocked, whereas (PG, G) are unblocked. Likewise, the following configurations are obtained for the remaining content rating systems: (TV-MA, TV-14) of EIT VCHIP ratings 304-2 are blocked while (TC-PG, TV-G, TV-Y7, TV-Y) are all unblocked; (NC-17, R, PG-13) are blocked and (PG, G) are unblocked in EIT MPAA Ratings 304-3; (A, RP, M, T) are blocked and (E10+, E, C) are unblocked in of ESRB Ratings 304-4; and, (FSK 18, FSK16) are blocked and (FSK 12, FSKO, FSK 6) are unblocked in German Movie Ratings 304-5. It can be seen that more than one category of a current content rating system (CRS) may be mapped to a single URC whose lock bit logic may be applied to each of the mapped categories. In other words, a single URC setting can be adapted to block or unblock a plurality of rating categories in a particular CRS. Further, because the mapping can be adapted to accommodate a variety of rating systems regardless of the content type, subscribers can conveniently manage individualized controls over different types of content in a typical content consumption environment with relative ease.

As pointed out previously, an embodiment URS lock bit logic setting/configuration and associated mapping mechanisms relative to existing rating systems may be implemented in various ways depending on, including but not limited to, where the databases/profiles are created, maintained, managed, and updated, subscriber-initiated implementation vs. service/operator-initiated implementation, and whether support for multiple client UE devices and/or servers is desired, inter alia. In one example implementation, a subscriber may create a suitable URS having appropriate control (e.g., parental control) by defining various rating categories, e.g., R1-Rn. Alternatively, an existing CRS may be used as a default “starting point” by the subscriber, wherein the existing rating categories operate as URCs. Regardless, the subscriber may then map the URCs to one or more existing rating systems as described above. Appropriate lock bit logic may be configured by the subscriber to block or unblock the URCs based on desired control settings. Whereas the foregoing acts, steps and associated structures may be implemented entirely in a client UE device environment (i.e., local URS implementation), the URS may also be created as a cloud/web service in an operator network (e.g., network 130 in FIG. 1) with which the subscriber may interact via a suitable interface effectuated by a client application. In such a scenario, the service node (e.g., service node 133) may trigger automatic blocking/unblocking of all existing rating systems that are mapped in the URS as part of the subscriber profile. The service node may also trigger a web service call or any other communication method to update or synchronize its URS mapping database with information from other network entities and/or any other connected client UE devices associated with the subscriber account. Furthermore, the service node may also transmit the updated URS information to all other client UE devices under the same subscriber account or other clients pursuant to applicable service agreements and other business/transactional logic.

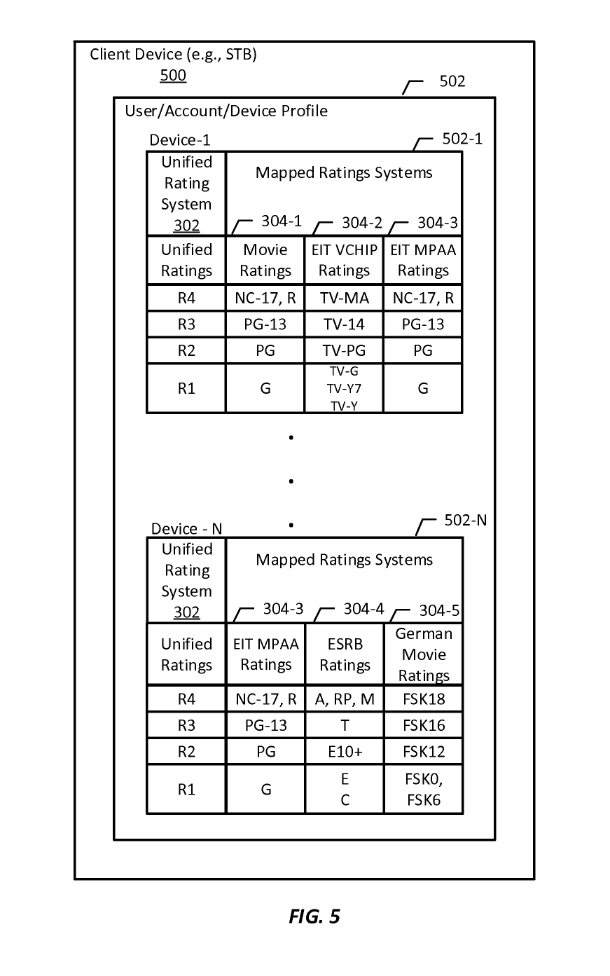

In an implementation initiated by the network service, an operator may create a suitable URS data structure using relevant user-defined rating categories (e.g., for one or more subscribers) or start with a default CRS. Thereafter, the operator configures appropriate mapping relationships between URCs (newly-created or default ratings) and one or more existing rating systems covering the various types of content, domestic or foreign, that the network service may wish to encompass. As with the subscriber-initiated implementation, the operator may enable blocking/unblocking of the URCs, which may be updated to or synchronized with respective clients' local rating profiles. In a still further implementation, a subscriber may be provided with a default CRS (locally stored or received from the server, e.g., via a request/response mechanism or otherwise), which the subscriber may apply to other existing systems and also update in the future as needed. These and other example embodiments/aspects will now be described hereinbelow in further detail in reference to FIGS. 5-11.

Turning to FIG. 5 in particular, depicted therein is an example client device implementation of a URS and subscriber/user profile for practicing an embodiment of the present patent disclosure. A client UE device 500 (an STB, smartphone, PC, laptop, tablet, or any content consuming device, for example), may be provided with a user profile data structure 502 (e.g., a simple file or a storage structure implemented in Extensible Markup Language (XML)) that may comprise device-specific URS/mapping schemes with respect to a plurality of client devices associated with a subscriber and/or its account. By way of example, a profile 502-1 applicable with respect to content to be consumed on Device-1 502-1 may involve its URS 302 and associated mapped rating systems. In similar fashion, another profile 502-N may be provided for content to be consumed on Device-N that may have its own URS and mapped rating systems associated therewith. It will be recognized that different device profiles may be combined into a structure having a single URS that may be partitioned on a device-by-device basis. As discussed hereinabove, the example subscriber/account profile 502 may be created/updated by the subscriber (or a set of authorized users having suitable privileges) or may initially be populated with a default entry database set by the system operator.

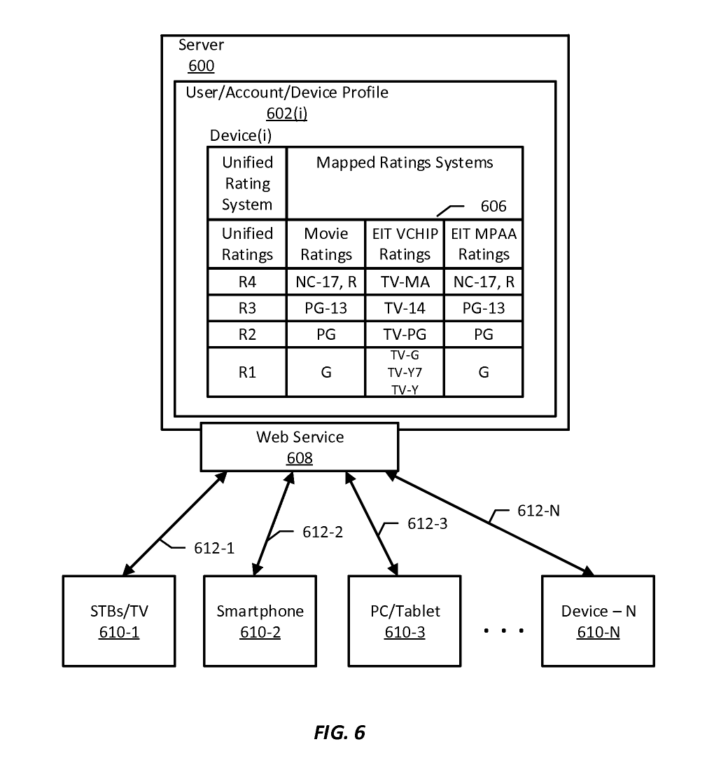

FIG. 6 depicts an example network server implementation of a URS and user profile for practicing a further embodiment or aspect of the present patent disclosure. A server node 600 may be provided with a suitable subscriber/account profile data structure that may comprise device-specific and/or client-specific profiles, e.g., profile 602(i) for Device (i) that may be associated with subscriber (j). In one configuration, the server node 600 may be exemplary of network node 130 in FIG. 1, and may be implemented as an operator node, system or element that a subscriber may interact with. A web service interface 608 associated with the server node 600 facilitates interactions with subscriber devices, e.g., devices 610-1 to 610-N, via suitable mechanisms, e.g., web service calls. In some configurations, subscriber interactions may be facilitated in conjunction with notification servers or cloud-messaging servers. Cumulatively, such interactive mechanisms are illustratively shown as communication paths 612-1 to 612-N corresponding to devices 610-1 to 610-N, which may include wired and/or wireless communications. When a client UE device belonging to the subscriber/account (identified in the server database structure) obtains a ratings update, the client UE device is operative to apply the URS categories and mappings locally at the client. Further, any changes to the URS data at the client UE level or server level may also be propagated across the devices as needed.

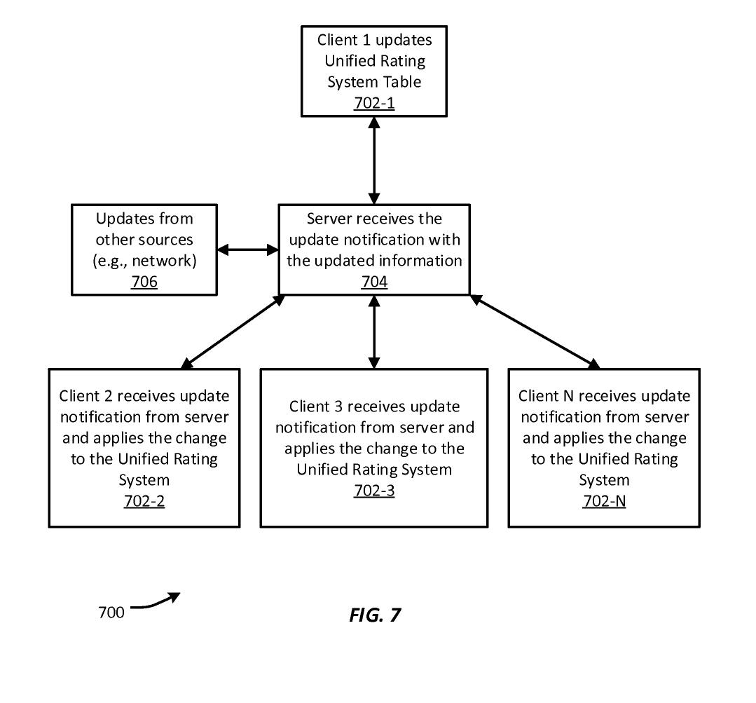

FIG. 7 depicts an example scheme 700 for automatically updating the URS configuration across a plurality of connected client UE devices or clients associated with a subscriber/user. When a client updates a URS table or other suitable data structure (block 702-1), appropriate parameters regarding the URS as well as optional client information may be transmitted to the server (block 704). The server thereafter triggers web service calls (e.g., mechanisms using Simple Object Access Protocol or SOAP, Java, Parley X, Asynchronous JavaScript and XML (AJAX), etc.) or any other suitable communication method to update and/or synchronize the URS update information with its URS database as well as all other connected client devices (blocks 702-2 to 702-N). Further, the server may also receive additional updates, notifications, etc. from other sources such as, e.g., content rating systems, content author/creator associations, content providers, distributors and publishers, governing/advisory/regulatory bodies concerned with content ratings, TV networks, programming guides, various third-party entities, and the like, which information may impact or be relevant to a URS (as indicated in block 706). Accordingly, such third-party information may also be used in updating or suitably modifying the URS databases across all the connected client devices.

FIG. 8 depicts a flowchart of various blocks, steps and/or acts with respect to a universal content rating method 800 according to an embodiment of the present patent disclosure. At block 802, appropriate functionality is operative to create a Unified Rating System (URS) by defining a set of classes of categories of ratings (e.g., effectuated by an end user or service operator), which are preferably customizable by and/or to end users. Alternatively, a default rating system's classes may be used as a starting point, which may be optionally modified or otherwise customized. Appropriate mapping relationships may be created (e.g., by the end user or service operator) that map relevant URS class/category identifiers to one or more existing rating systems available for various types/sources of content, e.g., broadcast TV shows, moves, programs, on-demand content, cartoons, graphic novels, video/computer games, audio titles, etc. from one or more rating bodies or jurisdictions (e.g., countries), as set forth at block 804. Although the mapping can be between the URS classes and rating categories/subcategories identified by textual names or other alphanumeric codes, the mapping can also be done with respect to other indicia, e.g., symbols, graphic icons, embedded markers, content descriptor codes, etc. Suitable blocking/unblocking filters may be enabled with respect to the URS rating classes by setting or otherwise enabling lock bits (i.e., lock bit logic configuration) corresponding to the URS classes as explained in detail hereinabove (block 806). Thereafter, the blocking/unblocking settings may be applied (e.g., triggered) to the existing/available rating systems based on the mapping of the rating categories to corresponding universal rating classes (block 808). Further, in some implementations, mappings and/or lock bit logic configurations may be updated based on client UE device location updates.

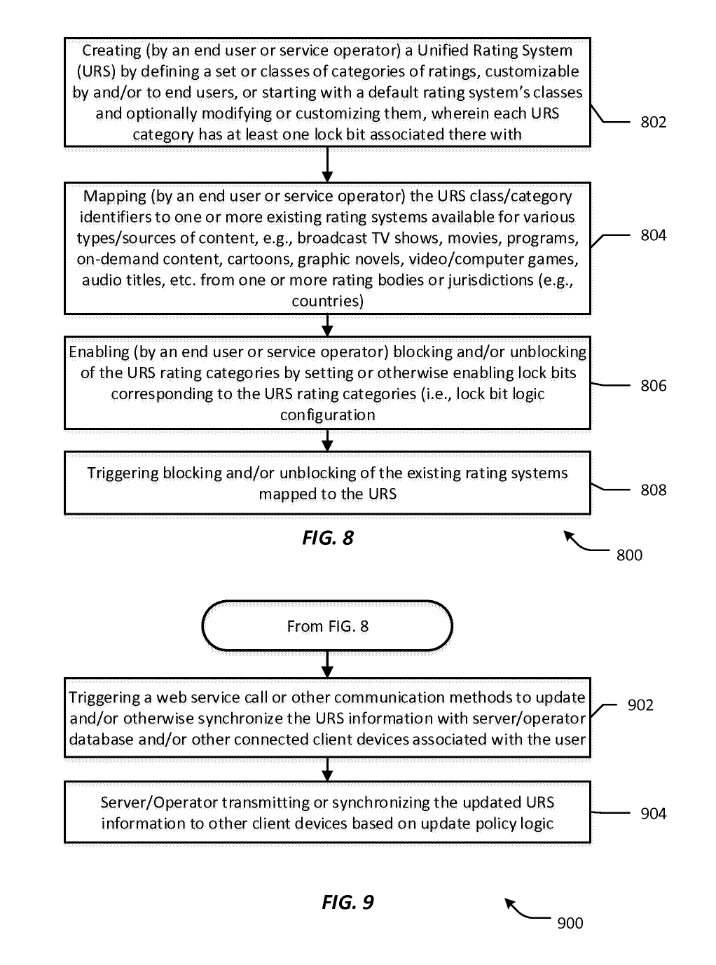

FIGS. 9-11 depicts flowcharts of various blocks, steps and/or acts illustrative of additional/alternative embodiments or aspects of the present patent disclosure. In particular, reference numeral 900 in FIG. 9 generally refers to additional features with respect to a database/profile synchronization process that may be augmented or otherwise incorporated, either partially or otherwise, into the methodology 800 set forth hereinabove, mutatis mutandis. A web service call or other communication methods may be trigged by the service operator (in a server implementation, for example) to update and/or otherwise synchronize the URS information with server/operator database or other connected client devices associated with the subscriber (block 902). The server/operator may further transmit the updated information to other client devices based on update policy logic, which may be configured by the user or service operator, for example (block 904).

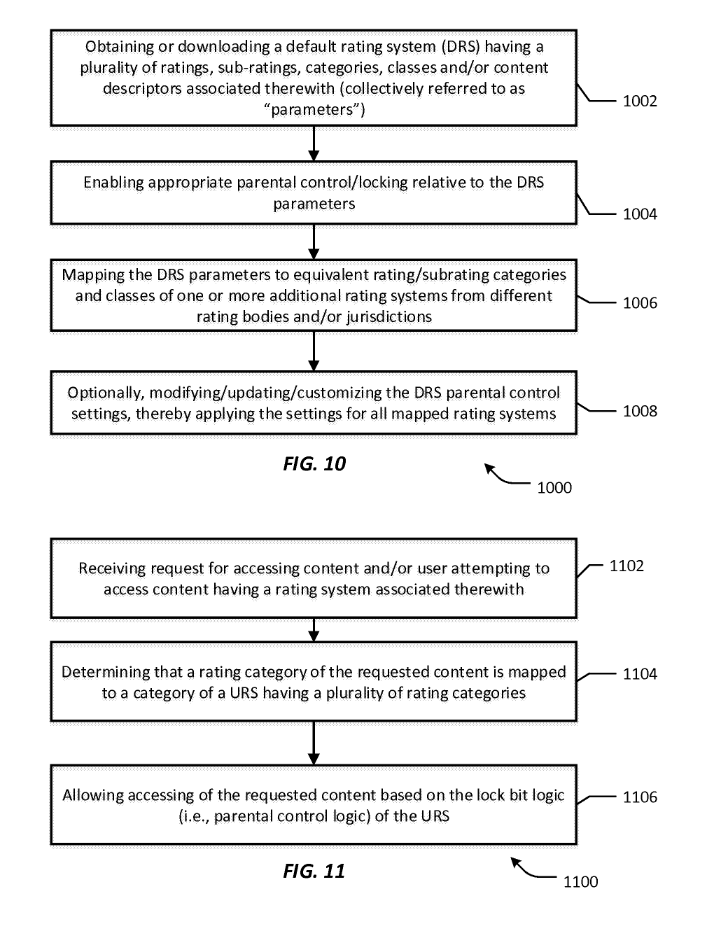

FIG. 10 depicts a flowchart of various blocks, steps and/or acts of a process 1000 that is illustrative of utilizing a default CRS for purposes of the present patent disclosure in certain aspects. At block 1002, a default rating system (DRS) may be downloaded, uploaded or otherwise obtained (either by the subscriber, network operator, at a client UE device or at a server node, depending on the implementation). As discussed above, such a DRS may comprise a plurality of existing ratings, sub-ratings, categories, classes and/or content descriptors associated therewith (collectively referred to as “parameters”), which may be initialized as a set of URCs or “reference content categories”. Thereafter, appropriate parental control/locking logic may be invoked or otherwise enabled relative to the apprpriate DRS parameters, now being treated as URCs (block 1004). Suitable mapping relationships are then established or otherwise configured between the DRS parameters and equivalent ratings, sub-ratings, categories and classes of one or more additional rating systems from different rating bodies and/or jurisdictions (block 1006). Optionally, the DRS parental control settings may be further modified, updated, or customized, thereby applying the updated parental controls across all mapped rating systems (block 1008). FIG. 11 depicts an example content consumption method 1100 in accordance with an embodiment of the present patent application. When a user attempts to access content having a rating system associated therewith or a request to access content has been made (block 1102), a determination may be made (either locally at the client UE device or at a network service entity (responsive to a user request to access the content, for example)) whether a rating category of the requested content is mapped to a category in a URS that is configured for allowing access (block 1104). The user is allowed accessing the requested content based on a lock bit logic (i.e., parental control, for example) configured for the URS category corresponding to the requested content's rating (block 1106).

FIG. 12 depicts a block diagram of example user equipment (UE) 1200 operable as a client device for purposes of the present patent disclosure. One or more processors 1202 coupled with memory 1204 may be provided for the overall control of various subsystems of the client UE device 1200 (which is exemplary of devices 106 in FIG. 1), wherein modules such as URS logic block 1206, mapping database 1208, account profile 1212 and a synchronization block 1210 may be implemented in appropriate hardware, software, firmware or in any combination thereof. One or more communication interfaces 1214 are operative with respect to functionalities such as server database synchronization, server control interaction, content delivery/consumption interaction, and the like, in addition to other local inter-device communications. Accordingly, interface block 1214 is representative of at least an interface with respect to one or more cable TV networks, satellite TV networks, IPTV networks, broadcast TV stations, movie-on-demand servers, video game networks and/or content stores, inter alia. A user interface 1216 may be configured to facilitate, under control of the processors 1202 and appropriate program instructions stored in persistent memory modules such as URS logic block 1206, an end user to define a set of URCs and configure appropriate controls and mappings according to one or more embodiments discussed in detail hereinabove.

Based upon the foregoing Detailed Description, it should be appreciated that one or more embodiments of the present disclosure can be advantageously implemented in a number of content consumption environments involving various content types and respective rating systems. In addition to allowing subscribers to define a single rating system that matches their respective content consumption habits, preferences, etc., embodiments set forth herein provide support across various client UE devices and network architectures in an intuitively user-friendly manner.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As alluded to previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Other blocks may also be added/inserted between the blocks that are illustrated. Whereas some of the diagrams include arrows on communication paths to show a primary direction of communication, it is to be understood that communication may occur in the opposite direction relative to the depicted arrows.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A universal content rating method, comprising:
defining a set of universal rating categories, each configured with at least a lock bit associated therewith;
mapping each universal rating category to at least one rating category of a content rating system available with respect to content from one or more content sources;
enabling at least one of blocking and unblocking of the universal rating categories by appropriately configuring lock bit logic associated therewith; and
triggering at least one of blocking and unblocking of rating categories of each available content rating system based on the mapping of the rating categories to corresponding universal rating categories.

2. The universal content rating method as recited in claim 1, wherein the acts of defining, mapping and enabling are performed by an end user at a client device, and further comprising synchronizing the lock bit logic and mapping of the universal rating categories with the end user's profile stored in a service operator database.

3. The universal content rating method as recited in claim 2, further comprising synchronizing the end user's profile with one or more user profiles locally stored respectively at other client devices associated with the end user.

4. The universal content rating method as recited in claim 1, wherein the acts of defining, mapping and enabling are performed by an end user at a client device, and further comprising synchronizing the lock bit logic and mapping of the universal rating categories with one or more user profiles locally stored respectively at other client devices associated with the end user.

5. The universal content rating method as recited in claim 1, wherein the acts of defining, mapping and enabling are performed by a service operator with respect to an end user, and further comprising synchronizing the lock bit logic and mapping of the universal rating categories with one or more user profiles locally stored respectively at one or more client devices associated with the end user.

6. The universal content rating method as recited in claim 1, wherein the lock bit logic is configured such that each universal rating category is associated with a corresponding lock bit and further wherein setting a particular lock bit to a Boolean “True” value is operative to block downloading of any content having a rating category that is mapped to a universal rating category having its lock bit set to the Boolean “True” value.

7. The universal content rating method as recited in claim 1, wherein the defining a set of universal rating categories is based on using a particular existing content rating system as a default rating system such that the particular existing content system's rating categories are mapped to other content rating systems.

8. The universal content rating method as recited in claim 1, wherein the content rating system comprises at least one of a TV rating system, a movie rating system, a video game rating system, an audio content rating system, and/or a content rating system provided by a rating body outside the United States.

9. A content consumption method, comprising:
receiving a request for accessing content having a rating system associated therewith;
determining that a rating category of the content is mapped to a category in a Unified Rating System (URS) having a plurality of universal content rating categories; and
allowing accessing of the content based on a lock bit logic associated with the universal content categories of the URS.

10. The content consumption method as recited in claim 9, wherein the lock bit logic is configured such that each universal rating category of the URS is associated with a corresponding lock bit and further wherein setting a particular lock bit to a Boolean “True” value is operative to block accessing of any content having a rating category that is mapped to a universal rating category having its lock bit set to the Boolean “True” value.

11. The content consumption method as recited in claim 9, wherein the content comprises at least one of a broadcast TV show, a cable TV show, a satellite TV show, an IPTV show, an on-demand movie, a video game, an audio title, and a content file from a content store.

12. The content consumption method as recited in claim 9, wherein the rating system comprises at least one of a TV rating system, a movie rating system, a video game rating system, an audio content rating system, and/or a content rating system provided by a rating body outside the United States.

13. The content consumption method as recited in claim 9, further comprising providing the URS at an end user's client device.

14. The content consumption method as recited in claim 9, further comprising providing the URS at a service operator network node with respect to an end user's profile.

15. A Unified Rating System (URS) for facilitating parental control over content, the URS comprising:
a plurality of memory locations configured to identify a set of universal content rating categories;
a plurality of lock bit locations respectively corresponding to the set of universal content rating categories; and
a lock bit logic block configured such that setting a particular lock bit to a Boolean “True” value is operative to block accessing of any content having a rating category that is mapped to a universal content rating category having its lock bit set to the Boolean “True” value, wherein the memory locations, lock bit locations and the lock bit logic block are implemented in a persistent memory.

16. The URS as recited in claim 15, wherein the persistent memory is provided as part of an end user's client device.

17. The URS as recited in claim 15, wherein the persistent memory is provided as part of a service operator network node.

18. A user equipment (UE) device, comprising:
one or more processors;
a user interface configured to facilitate, under control of the one or more processors executing stored program instructions, an end user to:
define a set of universal content rating categories, each universal content rating category configured with a lock bit associated therewith;
map each universal content rating category to at least one rating category of an existing content rating system available with respect to content from one or more content sources; and
enable blocking of one or more of the universal content rating categories by appropriately configuring respective lock bits, whereby setting a particular lock bit to a Boolean “True” value is operative to block accessing of any content having a rating category that is mapped to a universal content rating category having its lock bit set to the Boolean “True” value; and
a synchronization block operative to synchronize mapping of the universal rating categories with the end user's profile stored in a service operator database.

19. The UE device as recited in claim 14, wherein the synchronization block is further operative to synchronize mapping of the universal rating categories with one or more user profiles locally stored respectively at other UE devices associated with the end user.

20. The UE device as recited in claim 18, further comprising a transceiver block configured to receive content from at least one of a cable TV network, a satellite TV network, an IPTV network, a broadcast TV station, a movie-on-demand server, a video game network and/or a content file from a content store.

21. The UE device as recited in claim 20, wherein the received content is provided with an existing content rating system comprising at least one of a TV rating system, a movie rating system, a video game rating system, an audio content rating system, and/or a content rating system provided by a rating body outside the United States.
